(19) United States
(12) Patent Application Publication
(10) Pub. No.: US 2018/0204692 A1
(43) Pub. Date: Jul. 19, 2018

(54) KEYCAP AND METHOD FOR MANUFACTURING THE SAME

(71) Applicant: Chuang-Wei HUANG, Taichung City (TW)

(72) Inventor: Chuang-Wei HUANG, Taichung City (TW)

(21) Appl. No.: 15/433,364

(22) Filed: Feb. 15, 2017

(30) Foreign Application Priority Data
Jan. 13, 2017 (TW) 106101192

(51) Int. Cl. H01H 13/14; B29C 45/00; H01H 11/00

(52) U.S. Cl. CPC H01H 13/14; B29C 45/0046; B29L 2031/712; H01H 11/00; B29C 45/0017

(57) ABSTRACT

A method for manufacturing a keycap is provided, including the steps of: performing a first shot for injection-molding a first plastic layer which includes a planar face, a back face opposite to the planar face, a closed loop protrusion on the planar face and at least one passage communicating an interior and an exterior of the closed loop protrusion; performing a second shot for injection-molding a second plastic layer which is disposed on the first plastic layer, is different from the first plastic layer in color, includes an inner part within the closed loop protrusion, an outer part outside the closed loop protrusion and a connection portion connected with the inner and outer parts through the at least one passage; removing a part of the connection portion to expose a part of the first plastic layer from the back face of the first plastic layer.

### BACKGROUND OF THE INVENTION

### Field of the Invention

The present invention relates to a keycap and method for manufacturing the same.

### Description of the Prior Art

As shown in FIGS. 10 and 11, a conventional keycap 100 includes an inner cap body 110 which is light-penetrable and an outer cap body 120 which is light-impenetrable. A top side of the inner cap body 110 includes a letter (such as letter “O”) including a closed loop protrusion 111, and the outer cap body 120 is coated on the inner cap body 110 and exposes the closed loop protrusion 111. In order to permit a second injection material to flow into the interior space of the closed loop protrusion 111 formed by a first shot of injection-molding, the top side of the inner cap body 110 is formed to have a channel laterally communicating the interior and the exterior of the closed loop protrusion. However, a part of the outer cap body 120 is located under the closed loop protrusion 111 after molded. When illuminated by a backlight within the inner cap body 110, there is a shadow 112 caused on the closed loop protrusion 111, thus resulting in a poor quality image.

The present invention is, therefore, arisen to obviate or at least mitigate the above mentioned disadvantages.

### SUMMARY OF THE INVENTION

An object of the present invention is to provide a keycap and method for manufacturing the same, in which there is no shadow caused on a light-penetrable closed loop protrusion of the keycap.

To achieve the above and other objects, a method for manufacturing a keycap is provided, including the steps of: performing a first shot for injection-molding a first plastic layer which is light-penetrable and includes a planar face, a back face opposite to the planar face and a closed loop protrusion integrally formed on the planar face and includes at least one passage communicating an interior and an exterior of the closed loop protrusion; performing a second shot for injection-molding a second plastic layer which is disposed on the first plastic layer, is different from the first plastic layer in color, includes an inner part disposed on the planar face and within the closed loop protrusion, an outer part disposed on the planar face and outside the closed loop protrusion and a connection portion connected with the inner and outer parts through the at least one passage; removing a part of the connection portion corresponding to the closed loop protrusion from the back face of the first plastic layer so as to expose a part of the first plastic layer from the back face of the first plastic layer.

To achieve the above and other objects, a keycap is provided, including: a first plastic layer which is light-penetrable, including a planar face, a back face opposite to the planar face, a closed loop protrusion integrally formed on the planar face and an exposing opening on the back face; a second plastic layer, being different from the first plastic layer in color, including an inner part disposed on the planar face and within the interior of the closed loop protrusion and an outer part disposed on the planar face and outside the closed loop protrusion; wherein the first and second plastic layers are respectively partially exposed within the exposing opening.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1-2 are drawings showing a first shot for injection molding a first plastic layer according to a preferred embodiment of the present invention;

FIGS. 3-4 are drawings showing a second shot for injection molding a second plastic layer according to a preferred embodiment of the present invention;

FIGS. 5-6 are drawings showing steps for processing a keycap according to a preferred embodiment of the present invention;

FIG. 7 is a top view of a keycap according to a preferable embodiment of the present invention;

FIG. 8 is a drawing of a first plastic layer according to another preferable embodiment of the present invention;

FIG. 9 is a cross-sectional view according to a preferable embodiment of the present invention; and

FIGS. 10-11 are drawings showing a conventional keycap.

### DETAILED DESCRIPTION OF THE PREFERRED EMBODIMENTS

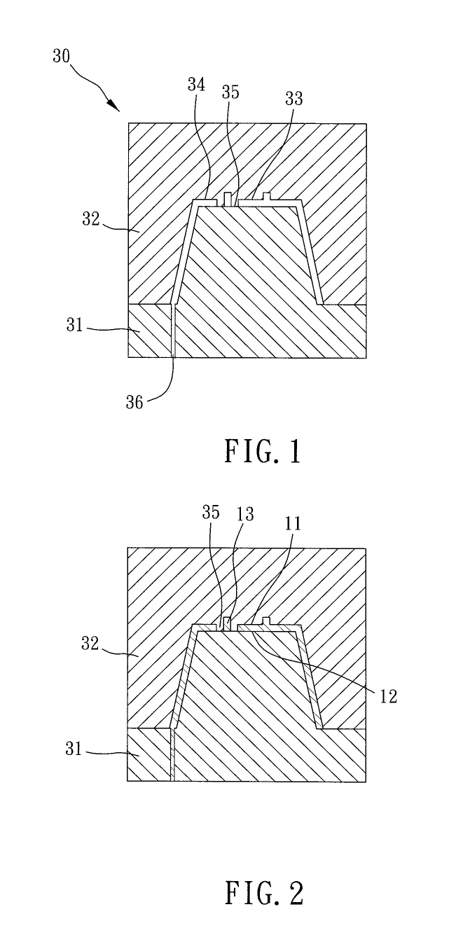

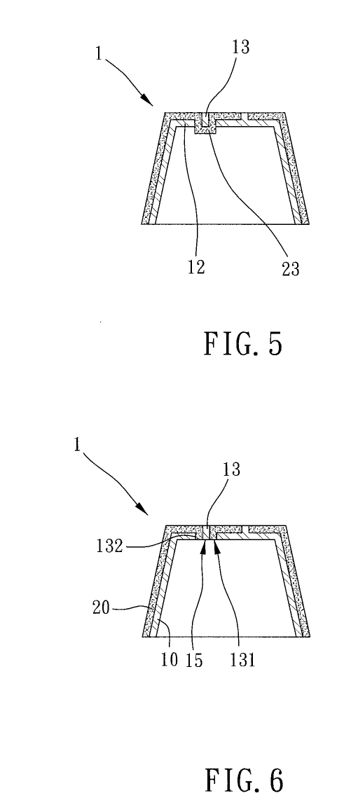

FIGS. 1-6 show a method for manufacturing a keycap according to a preferred embodiment of the present invention. The method includes the following steps. A first shot of injection molding is performed to form a first plastic layer 10 which is light-penetrable, the first plastic layer 10 includes a planar face 11, a back face 12 opposite to the planar face 11 and a closed loop protrusion 13 (letter “O”, or any letter or pattern including a closed loop protrusion such as letters “A”, “B”, “D”) integrally formed on the planar face 11, and the first plastic layer 10 includes at least one passage 14 communicating an interior and an exterior of the closed loop protrusion 13. A second shot of injection molding is performed to form a second plastic layer 20 on the first plastic layer 10, the second plastic layer 20 and the first plastic layer 10 are different in color, or the second plastic layer 20 has lower transmittance than the first plastic layer 10 or is light-impenetrable. The term “difference of color” may be resulted from colors of injection plastic materials, difference of visual feeling due to different transmittances of different plastic layers, physical or chemical variation of injection plastic material. The second plastic layer 20 includes an inner part 21 disposed on the planar face 11 and within the closed loop protrusion 13, an outer part 22 disposed on the planar face 11 and located within the closed loop protrusion 13, and a connection portion 23 integrally connected with the inner part 21 and the outer part 22 through the at least one passage 14. A part of the connection portion 23 corresponding to the closed loop protrusion 13 is removed from the back face 12 of first plastic layer 10 the first plastic layer 10 so as to expose a part of the first plastic layer 10 from the back face 12. Whereby, when illuminated from the back face 12 by a backlight, there is no shadow caused on the closed loop protrusion 13, and the closed loop protrusion 13 is evenly-light-penetrable, thus resulting in a high quality image. In other processes, in the first shot of injection molding, the at least one passage may be formed to be a channel laterally communicating the interior and the exterior of the closed loop protrusion 13, the channel may be a through slot 14a recessed from the planar face (as shown in FIG. 8) or a groove recessed on the planar face, or a through hole disposed through an annular wall of the closed loop protrusion. The first and second plastic layers 10, 20 may be thermoplastic material, resin or the like.

As shown in FIGS. 1 and 2, the first shot for injection-molding the first plastic layer is performed in a first injection mold 30 including a first mold 31 and a second mold 32. The second mold 32 includes a protrusive core 33, a concave portion 34 disposed around the protrusive core 33, and a plurality of spacers 35 respectively protruding from the protrusive core 33 and the concave portion 34. The protrusive core 33 and the plurality of spacers 35 abut against the first mold 31, and a first plastic material is injected between the first mold 31 and the second mold 32 to form the first plastic layer 10.

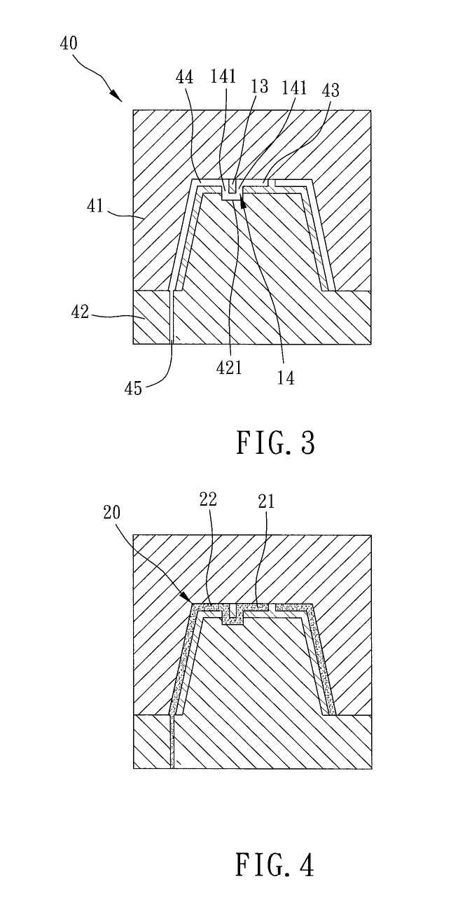

As shown in FIGS. 3-5, in the second shot for injection-molding the second plastic layer, the first plastic layer 10 is disposed in a second injection mold 40 including a third mold 41 and a fourth mold 42. The third mold 41 annularly abuts against the closed loop protrusion 13 to define an interior space 43 and is spaced apart from the planar face 11 of the first plastic layer 10 to form a gap 44. The fourth mold 42 includes a recession 421 communicating the interior space 43 and the gap 44. A second plastic material is injected between the third mold 41 and the fourth mold 42 to form the second plastic layer 20. Preferably, in the second shot for injection-molding the second plastic layer, the closed loop protrusion 13 and the second plastic layer 20 are in alignment with each other, and the connection portion 23 is formed to be protrusive relative to the back face 12 of the first plastic layer 10.

In the first and second shots of injection molding, the first injection mold 30 is provided with a single injecting hole 36, and the second injection mold 40 is provided with a single injecting hole 45, thus having simple structures. The first and second injection molds 30, 40 may includes a plurality of injecting holes.

In this embodiment, in the first shot for injection-molding the first plastic layer, the first plastic layer 10 is formed with a plurality of through holes 141 which are located at the planar face 11 and respectively within and outside the closed loop protrusion 13. The plurality of through holes 141 serve as the at least one passage 14; in the second shot for injection-molding the second plastic layer, the connection portion 23 is formed to be integrally connected with the inner part 21 and the outer part 22 through the at least one passage 14 at the back face 12 of the first plastic layer 10.

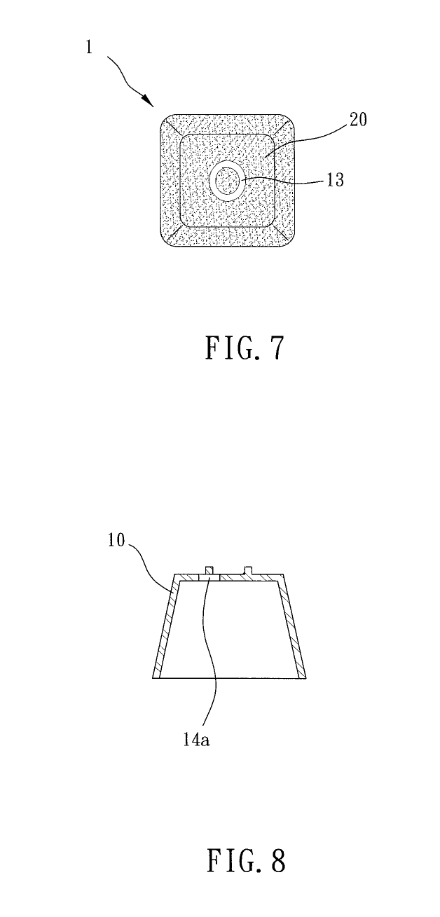

As shown in FIG. 6, a part of the connection portion 23 corresponding to the closed loop protrusion 13 is removed from the back face 12 of the first plastic layer 10 so as to expose a part of the first plastic layer 10 from the back face 12 of the first plastic layer 10. The keycap 1 is completed (FIGS. 6 and 7).

As shown in FIGS. 6 and 7, a keycap 1 is provided, and it may be manufactured by the aforementioned method or other methods. The keycap 1 includes a first plastic layer 10 and a second plastic layer 20. The first plastic layer 10 is light-penetrable. The first plastic layer 10 includes a planar face 11, a back face 12 opposite to the planar face 11, a closed loop protrusion 13 integrally formed on the planar face 11, and an exposing opening 132 on the back face 12. The second plastic layer 20 and the first plastic layer 10 are different in color. The second plastic layer 20 includes an inner part 21 disposed on the planar face 11 and within the closed loop protrusion 13, and an outer part 22 disposed on the planar face 11 and outside the closed loop protrusion 13. The first and second plastic layers 10, 20 are respectively partially exposed within the exposing opening 132. Whereby, there is no shadow caused on the closed loop protrusion 13, and the closed loop protrusion 13 is evenly-light-penetrable.

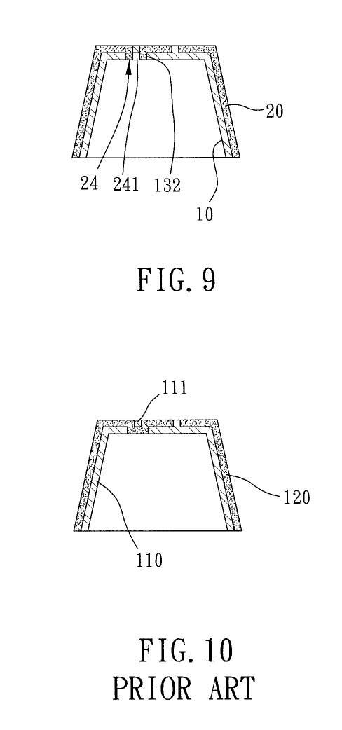

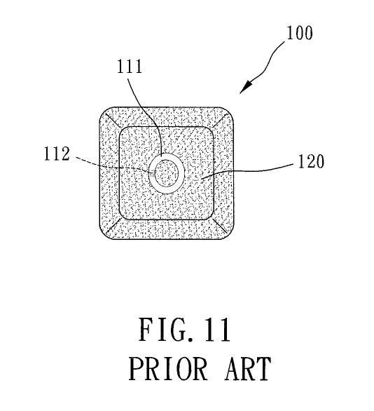

Preferably, the closed loop protrusion 13 and the second plastic layer 20 are in alignment with each other. An exposed part 15 of the first plastic layer 10 and an exposed part 131 of the second plastic layer 20 are in alignment with the back face 12 of the first plastic layer 10 (as shown in FIG. 6), thus having a substantially fixed thickness and good structural strength. It is noted that the second plastic layer 20 may further include an embedded part 24 located within the exposing opening 132 and embedded in the first plastic layer 10, and the embedded part 24 includes a mouth 241 for exposing a part of the closed loop protrusion (as shown in FIG. 9), which has simple structure and process.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method for manufacturing a keycap, including the steps of:
performing a first shot for injection-molding a first plastic layer which is light-penetrable and includes a planar face, a back face opposite to the planar face and a closed loop protrusion integrally formed on the planar face and includes at least one passage communicating an interior and an exterior of the closed loop protrusion;
performing a second shot for injection-molding a second plastic layer which is disposed on the first plastic layer, is different from the first plastic layer in color, includes an inner part disposed on the planar face and within the closed loop protrusion, an outer part disposed on the planar face and outside the closed loop protrusion and a connection portion connected with the inner and outer parts through the at least one passage;
removing a part of the connection portion corresponding to the closed loop protrusion from the back face of the first plastic layer so as to expose a part of the first plastic layer from the back face of the first plastic layer.

2. The method of claim 1, wherein the first shot for injection-molding the first plastic layer is performed in a first injection mold including a first mold and a second mold, the second mold includes a protrusive core, a concave portion disposed around the protrusive core and a plurality of spacers respectively protruding from the protrusive core and the concave portion, the protrusive core and the plurality of spacers abut against the first mold, a first plastic material is injected between the first mold and the second mold to form the first plastic layer; in the second shot for injection-molding the second plastic layer, the first plastic layer is disposed in a second injection mold including a third mold and a fourth mold, the third mold annularly abuts against the closed loop protrusion to define an interior space and is spaced apart from the planar face of the first plastic layer to form a gap, the fourth mold includes a recession communicating the interior space and the gap, a second plastic material is injected between the third mold and the fourth mold to form the second plastic layer.

3. The method of claim 2, wherein in the first shot for injection-molding the first plastic layer and in the second shot for injection-molding the second plastic layer, each of the first and second injection molds is provided with a single injecting hole.

4. The method of claim 1, wherein in the first shot for injection-molding the first plastic layer, the first plastic layer is formed with a plurality of through holes which are located at the planar face and respectively within and outside the closed loop protrusion, the plurality of through holes serve as the at least one passage; in the second shot for injection-molding the second plastic layer, the connection portion is formed to be integrally connected with the inner part and the outer part through the at least one passage at the back face of the first plastic layer.

5. The method of claim 2, wherein in the first shot for injection-molding the first plastic layer, the first plastic layer is formed with a plurality of through holes which are located at the planar face and respectively within and outside the closed loop protrusion, the plurality of through holes serve as the at least one passage; in the second shot for injection-molding the second plastic layer, the connection portion is formed to be integrally connected with the inner part and the outer part through the at least one passage at the back face of the first plastic layer.

6. The method of claim 3, wherein in the first shot for injection-molding the first plastic layer, the first plastic layer is formed with a plurality of through holes which are located at the planar face and respectively within and outside the closed loop protrusion, the plurality of through holes serve as the at least one passage; in the second shot for injection-molding the second plastic layer, the connection portion is formed to be integrally connected with the inner part and the outer part through the at least one passage at the back face of the first plastic layer.

7. The method of claim 1, wherein in the first shot for injection-molding the first plastic layer, and the at least one passage is formed to be a channel laterally communicating the interior and the exterior of the closed loop protrusion.

8. The method of claim 2, wherein in the first shot for injection-molding the first plastic layer, and the at least one passage is formed to be a channel laterally communicating the interior and the exterior of the closed loop protrusion.

9. The method of claim 3, wherein in the first shot for injection-molding the first plastic layer, and the at least one passage is formed to be a channel laterally communicating the interior and the exterior of the closed loop protrusion.

10. The method of claim 1, wherein in the second shot for injection-molding the second plastic layer, the connection portion is formed to be protrusive relative to the back face of the first plastic layer.

11. The method of claim 2, wherein in the second shot for injection-molding the second plastic layer, the connection portion is formed to be protrusive relative to the back face of the first plastic layer.

12. The method of claim 3, wherein in the second shot for injection-molding the second plastic layer, the connection portion is formed to be protrusive relative to the back face of the first plastic layer.

13. A keycap, including:
a first plastic layer which is light-penetrable, including a planar face, a back face opposite to the planar face, a closed loop protrusion integrally formed on the planar face and an exposing opening on the back face;
a second plastic layer, being different from the first plastic layer in color, including an inner part disposed on the planar face and within the interior of the closed loop protrusion and an outer part disposed on the planar face and outside the closed loop protrusion;
wherein the first and second plastic layers are respectively partially exposed within the exposing opening.

14. The keycap of claim 13, wherein the closed loop protrusion and the second plastic layer are in alignment with each other.

15. The method of claim 13, wherein the second plastic layer includes an exposed part in alignment with the back face of the first plastic layer.

16. The method of claim 14, wherein the second plastic layer includes an exposed part in alignment with the back face of the first plastic layer.

17. The method of claim 13, wherein the second plastic layer further includes an embedded part located within the exposing opening and embedded in the first plastic layer, and the embedded part includes a mouth for exposing a part of the closed loop protrusion.

18. The method of claim 14, wherein the second plastic layer further includes an embedded part located within the exposing opening and embedded in the first plastic layer, and the embedded part includes a mouth for exposing a part of the closed loop protrusion.
